(19) United States
(12) Patent Application Publication
(10) Pub. No.: US 2022/0222300 A1
(43) Pub. Date: Jul. 14, 2022

(54) SYSTEMS AND METHODS FOR TEMPORAL AND VISUAL FEATURE DRIVEN SEARCH UTILIZING MACHINE LEARNING

(71) Applicant: Thomas Franklin Patterson, III, Gilroy, CA (US)

(72) Inventor: Thomas Franklin Patterson, III, Gilroy, CA (US)

(21) Appl. No.: 17/144,856

(22) Filed: Jan. 8, 2021

(51) Int. Cl. G06F 16/953; G06N 20/00

(52) U.S. Cl. CPC G06F 16/953; G06N 20/00

(57) ABSTRACT

A system for temporal and visual feature driven search utilizing machine learning, including a trained programmatic base configured to analyze files for visual feature information, generate a visual feature summary based on the visual feature information, and send the visual feature summary to a database, a database configured to receive the visual feature summary from the trained programmatic base and store the visual feature summary, a local monitoring device configured to monitor local user behavior, extract temporal and visual information and files based on the local user behavior, and send the temporal and visual information and files to the trained programmatic base, and a search application device configured to receive search instructions from a user and send the search instructions to the trained programmatic base and wherein the search application device is also configured to receive search results from the trained programmatic base and display the search results.

### TECHNICAL FIELD

The present disclosure relates to the technical field of machine learning and, more particularly, to systems and methods for temporal and visual feature driven searching that utilizes machine learning.

### BACKGROUND

With the development of search engines, there has become an increased need for greater accuracy of search results and speed. One of the primary drawbacks of current search engines relates to the kind of inputs required to generate accurate results in a desirable timespan. Local search engines rely on knowledge of certain samples of text in a document or the documents name in order to produce accurate and reliable results. Web based search engines also require knowledge of text-based information contained in a webpage or the URL of the webpage. These requirements contradict the very basis of human nature and our reliance on visual and temporal features and information. Because of this, results from search engines are often unreliable or require multiple attempts using various terms to find the desired information and users of these search engines suffer as a result.

### SUMMARY

The following presents a simplified overview of the example embodiments in order to provide a basic understanding of some embodiments of the example embodiments. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented hereinbelow. It is to be understood that both the following general description and the following detailed description are exemplary and explanatory only and are not restrictive.

To minimize the limitations in the art, and to minimize other limitations that will become apparent upon reading and understanding the present specification, the present specification discloses new and improved systems and methods for a temporal and visual feature driven search utilizing machine learning.

The embodiments of the present disclosure provide a system. The system includes a trained programmatic base configured to analyze files for visual feature information, generate a visual feature summary based on the visual feature information, and send the visual feature summary to a database, a database configured to receive the visual feature summary from the trained programmatic base and store the visual feature summary, a local monitoring device/program configured to monitor local user behavior, extract temporal information and files based on the local user behavior, and send the temporal information and files to the trained programmatic base, and a search application device configured to receive search instructions from a user and send the search instructions to the trained programmatic base and wherein the search application device is also configured to receive search results from the trained programmatic base and display the search results.

Consistent with some embodiments, the present disclosure also provides a method that includes analyzing files for visual feature information, generating a visual feature summary based on the visual feature information, monitoring local user behavior, extracting temporal information based on the local user behavior, storing the visual feature summary and the temporal information, receiving search instructions from a user, generating search results based on the received search instructions, the stored visual feature summaries, and the temporal information, and displaying the search results.

Consistent with some embodiments, the present disclosure also provides a non-transitory computer-readable storage medium that stores a set of instructions that is executable by at least one processor of a temporal and visual feature driven search device. When executed, the set of instructions cause the temporal and visual feature driven search device to perform a method that includes analyzing files for visual feature information, generating a visual feature summary based on the visual feature information, monitoring local user behavior, extracting temporal information based on the local user behavior, storing the visual feature summary and the temporal information, receiving search instructions from a user, generating search results based on the received search instructions, the stored visual feature summaries, and the temporal information, and displaying the search results.

Additional features and advantages of the disclosed embodiments will be set forth in part in the following description, and in part will be apparent from the description, or may be learned by practice of the embodiments. The features and advantages of the disclosed embodiments may be realized and attained by the elements and combinations set forth in the claims.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate embodiments consistent with the systems and methods of the present disclosure and, together with the description, explain the principles of the systems and methods of the present disclosure. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIG. 1 illustrates a block diagram of an exemplary system for temporal and visual feature driven search utilizing machine learning, consistent with some embodiments of the disclosure.

FIG. 2 illustrates another block diagram of an exemplary system for temporal and visual feature driven search utilizing machine learning, consistent with some embodiments of the disclosure.

FIG. 3 illustrates an exemplary file comprising visual features, consistent with some embodiments of the disclosure.

FIG. 4 illustrates another exemplary file comprising visual features and temporal information, consistent with some embodiments of the disclosure.

FIG. 5 illustrates a block diagram of an exemplary trained programmatic base, consistent with some embodiments of this disclosure.

FIG. 6 is a flowchart of an exemplary method for temporal and visual feature driven search utilizing machine learning, consistent with some embodiments of this disclosure.

### DESCRIPTION OF THE EMBODIMENTS

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the systems and methods of the present disclosure. Instead, they are merely examples of systems and methods consistent with aspects related to the systems and methods of the present disclosure as recited in the appended claims.

In the following detailed description of various embodiments, numerous specific details are set forth in order to provide a thorough understanding of various aspects of the embodiments. However, these embodiments may be practiced without some or all of these specific details. In other instances, well-known methods, procedures, and/or components have not been described in detail so as not to unnecessarily obscure aspects of the embodiments.

While multiple embodiments are disclosed, still other will become apparent to those skilled in the art from the following detailed description. As will be realized, these embodiments are capable of modifications in various obvious aspects, all without departing from the spirit and scope of protection. Accordingly, the graphs, figures, and the detailed descriptions thereof, are to be regarded as illustrative in nature and not restrictive. Also, the reference or non-reference to a particular embodiment shall not be interpreted to limit the scope of protection.

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are signify both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that may be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all embodiments of this application including, but not limited to, steps in disclosed methods. Thus, if there are a variety of additional steps that may be performed it is understood that each of these additional steps may be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware embodiments. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded onto a general-purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, may be implemented by special purpose hardware-based computer systems that perform the specified functions or steps, or combinations of special purpose hardware and computer instructions.

In the following description, certain terminology is used to describe certain features of one or more embodiments. For purposes of the specification, unless otherwise specified, the term “substantially” refers to the complete or nearly complete extent or degree of an action, characteristic, property, state, structure, item, or result. For example, in one embodiment, an object that is “substantially” located within a housing would mean that the object is either completely within a housing or nearly completely within a housing. The exact allowable degree of deviation from absolute completeness may in some cases depend on the specific context. However, generally speaking, the nearness of completion will be so as to have the same overall result as if absolute and total completion were obtained. The use of “substantially” is also equally applicable when used in a negative connotation to refer to the complete or near complete lack of an action, characteristic, property, state, structure, item, or result.

As used herein, the terms “approximately” and “about” generally refer to a deviance of within 5% of the indicated number or range of numbers. In one embodiment, the term “approximately” and “about”, may refer to a deviance of between 0.001-10% from the indicated number or range of numbers.

Various embodiments are now described with reference to the drawings. In the following description, for purposes of explanation, numerous specific details are set forth in order to provide a thorough understanding of one or more embodiments. It may be evident, however, that the various embodiments may be practiced without these specific details. In other instances, well-known structures and devices are shown in block diagram form to facilitate describing these embodiments.

In the following description, certain terminology is used to describe certain features of the embodiments disclosed herein. For instance, the terms “computer”, “computer system”, “computing device”, mobile computing device”, “electronic data processing unit”, or “server” refer to any device that processes information with an integrated circuit chip, including without limitation, personal computers, mainframe computers, workstations, servers, desktop computers, portable computers, laptop computers, embedded computers, wireless devices, including cellular phones, personal digital assistants, tablets, tablet computers, smart phones, portable game players, wearables, smart devices and hand-held computers.

As used herein, the term “Internet” refers to any collection of networks that utilizes standard protocols, whether Ethernet, Token ring, Wi-Fi, asynchronous transfer mode (ATM), Fiber Distributed Data Interface (FDDI), code division multiple access (CDMA), global systems for mobile communications (GSM), long term evolution (LTE), or any combination thereof.

As used herein, the term “website” refers to any document written in a mark-up language including, but not limited to, hypertext mark-up language (HTML) or virtual reality modeling language (VRML), dynamic HTML, extended mark-up language (XML), wireless markup language (WML), or any other computer languages related thereto, as well as to any collection of such documents reachable through one specific Internet Protocol Address or at one specific World Wide Web site, or any document obtainable through any particular Uniform Resource Locator (URL). Furthermore, the terms “webpage,” “page,” “website,” or “site” refers to any of the various documents and resources on the World Wide Web, in HTML/XHTML format with hypertext links to enable navigation from one page or section to another, or similar such resources used on the Internet.

Embodiments of the present disclosure are directed to systems and methods for temporal and visual feature driven search utilizing machine learning. For example, the embodiments of the present disclosure use machine learning to determine temporal and visual features associated with certain documents and user actions relating to those documents. Further, machine learning is able to interpret and match search instructions from a user with stored temporal and visual features to determine the associated documents and web pages. As a result, a user is enabled to conduct a system or webpage search based primarily on temporal and visual features allowing for a more accurate, intuitive, and efficient search.

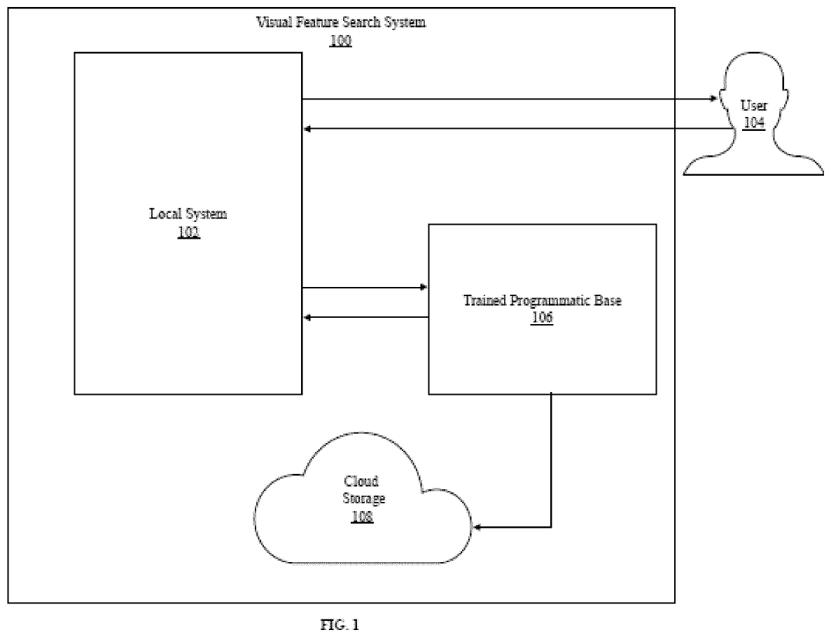

FIG. 1 illustrates a block diagram of an exemplary visual feature search system 100, according to embodiments of the disclosure. Visual feature search system 100 may include a local system 102, a trained programmatic base 106, and a cloud storage 108. Furthermore, visual feature search system 100 may be configured to be operable or accessed by a user 104.

As illustrated in FIG. 1, local system 102 may interface with user 104 through a variety of different peripheral input/output interfaces (touch screens, keyboards, mouses, and the like). As referred to herein, local system 102 may be a computing device (e.g., such as a personal computer (PC), a tablet, a smartphone, other smart device, and the like). In some embodiments, local system 102 can include one or more devices or applications, which are further described below. Each of the local system 102 and trained programmatic base 106 can be associated with its own memory device (e.g., cloud storage 108).

As illustrated in FIG. 1, local system 102 may also be connected with trained programmatic base 106 through a peripheral interface. Local system 102 may be configured to send and receive instructions to the trained programmatic base 106 through the peripheral interface. Furthermore, trained programmatic base 106 may also be configured to send and receive instructions to local system 102 through the peripheral interface.

As also illustrated in FIG. 1, trained programmatic base 106 may be connected to cloud storage 108 through a peripheral interface. Trained programmatic base 106 may be configured to send instructions to cloud storage 108 causing cloud storage 108 to store certain information, trained programmatic base 106 may also retrieve information from cloud storage 108. In some embodiments, trained programmatic base 106 and cloud storage 108 may be contained in the same device. In some embodiments, cloud storage 108 may be a database, either local or remote.

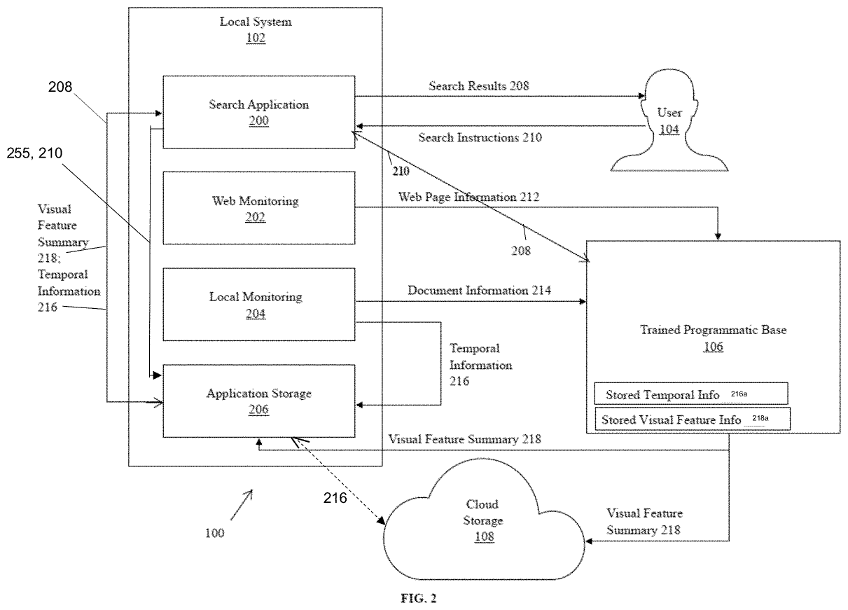

FIG. 2 illustrates another block diagram of an exemplary visual feature search system 100, according to embodiments of the disclosure. As shown in FIG. 2, local system 102 may comprise search application 200, web monitoring 202, local monitoring 204, and application storage 206.

As shown in FIG. 2, search application 200 may be engageable by a user 104 through a peripheral input/output interface. Search application 200 may be further configured to receive search instructions 210 from user 104 through the peripheral interface. Furthermore, search application 200 may also be configured to send search results 208 to user 104 through the peripheral interface.

As illustrated in FIG. 2, web monitoring 202 may be connected to trained programmatic base 106 through a peripheral interface. Web monitoring 202 may be further configured to send web page information 212 to trained programmatic base 106. Web monitoring 202 may be further configured to retrieve web page information 212 from local system 102 based on user 104 interacting with local system 102. For example, in some embodiments, user 104 may open a webpage using a web browser running on local system 102. Web monitoring 202 may monitor the web browser/s running on local system 102 and determine web page information 212. Web monitoring 202 may then send the web page information 212 to trained programmatic base 106 for analysis and storage.

As illustrated in FIG. 2, local monitoring 204 may be connected to trained programmatic base 106 through a peripheral interface. Local monitoring 204 may be further configured to send document information 214 to trained programmatic base 106. Local monitoring 204 may also be connected to application storage 206 through a peripheral interface. Local monitoring 204 may be further configured to send temporal information 216 to application storage 206. Local monitoring 204 may be further configured to retrieve document information 214 from local system 103 based on user 104 interacting with local system 102. For example, in some embodiments, user 104 may open a document using a word processor or other application running on local system 102. Local monitoring 204 may monitor the word processor or other applications running on the local system 102. When user 104 saves a document to local system 102, local monitoring 204 may send a document information 214 based on the saved document to trained programmatic base 106 for analysis and storage.

In some embodiments, when user 104 saves a document to local system 102, local monitoring may determine temporal information 216 and send temporal information 216 to application storage 108 for storage and later retrieval.

As shown in FIG. 2, application storage 206 may be connected to local monitoring 204, trained programmatic base 106, and search application 200 through a peripheral interface. Application storage 206 may be configured to receive temporal information 216 from local monitoring 204 as described above. Furthermore, application storage 206 may also be configured to receive feature summary information 218 from trained programmatic base 106 for local storage. For example, trained programmatic base 106 may receive web page information 212 and document information 214 from web monitoring 202 and local monitoring 204 respectively. In some embodiments, trained programmatic base 106 may analyze web page information 212 and document information 214 to determine visual feature summary 218.

In some embodiments, trained programmatic base 106 may use machine learning to determine visual features contained in web page information 212 and document information 214. For example, trained programmatic base 106 may comprise a neural engine trained and configured to determine visual features of web page information 212 and document information 214. Trained programmatic base 106 may then generate a summary of these visual features and send the feature summary information 218 to application storage 206 and cloud storage 108 for storage.

In some embodiments, application storage 206 may be configured to send temporal information 218 and visual feature summary 216 to search application 200 in order to generate search results 208. For example, search application 200 may receive search instructions 210 from user 104. In response, search application 200 may analyze search instructions 210 and send request 255 to application storage 206 to retrieve temporal information 218 and visual feature summary 216 corresponding with received search instructions 210.

In other embodiments, application storage 206 may be configured to receive search instructions 210 from search application 200 after search application 200 receives search instructions 210 from user 104. Application storage 206 may then be configured to analyze search instructions 210 and send results 208 to search application 200 based on temporal information 218 and visual feature summary 216.

In still other embodiments, search application 200 may be configured to receive search instructions 210 from user 104 and forward search instructions 210 to trained programmatic base 106 for analysis and response. For example, search application 200 may send search instructions 210 to trained programmatic base 106. Trained programmatic base 106 may then parse and analyze search instructions 210 and compare against stored visual feature information 208a and stored temporal information 216a. Trained programmatic base 106 may then produce search results 208, which trained programmatic base 106 then sends to search application 200. Search application 200 may be further configured to receive search results 208 from trained programmatic base 106 and send search results 208 to user 104.

As shown in FIG. 2, cloud storage 108 may be connected to trained programmatic base 106 through a peripheral interface. Cloud storage 108 may be configured to receive visual feature summary 218 from trained programmatic base 106. In some embodiments, cloud storage 108 may be a remote server connected to trained programmatic base 106 through an ethernet connection. In other embodiments, cloud storage 108 may be a local server contained in the same device and/or local system of the trained programmatic base 106.

Collectively the webpage information and document information may be collectively referred to as file information and webpages and documents may collectively be referred to as files.

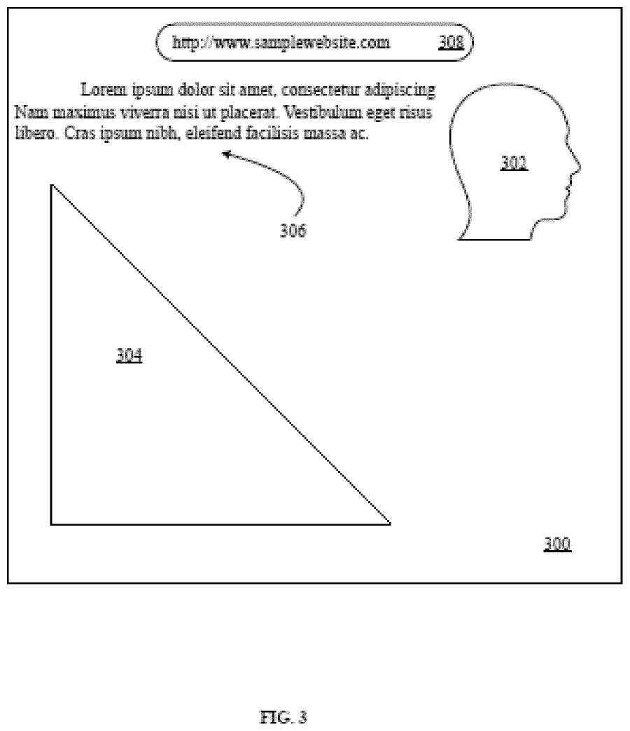

FIG. 3 illustrates an exemplary file comprising visual features, consistent with some embodiments of the disclosure. As shown in FIG. 3, webpage 300 may comprise webpage visual features 302 and 304, webpage text 306, and webpage URL 308.

As illustrated in FIG. 3, there may be multiple webpage visual features, such as webpage visual features 302 and 304. Each of the webpage visual features 302 and 304 may have a shape, color, contrast, silhouette, patterns, and other attributes. Webpage visual attributes 302 and 304 may refer to shapes, images, likenesses, patterns, or even background colors.

In some embodiments, trained programmatic base 106 may be configured to analyze webpages, such as webpage 300, and extract and analyze details about visual features in the webpages, such as visual features 302 and 304. Trained programmatic base 106 may contain a machine learning module that is programmed and/or trained to determine visual features based on website details and information. For example, webpage visual feature 302 may be analyzed and determined to be an image of a face in profile and webpage visual feature 304 may be analyzed and determined to be a triangle shape. Furthermore, color/s may be determined for each webpage visual feature 302, 304.

In some embodiments, trained programmatic base 106 may be configured to associate a URL (e.g., URL 308) corresponding with a webpage, such as webpage 300, with webpage visual features such as webpage visual features 302 and 304. For example, trained programmatic base 106 may associate URL 308, and thereby webpage 300, with a visual feature summary 218 based on webpage visual features 302 and 304. When user 104 sends search instructions corresponding with visual features 302 and/or 304, trained programmatic base 106 may produce search results 208 corresponding with URL 308 and thereby webpage 300, allowing user 104 to access webpage 300 based solely on knowledge of webpage visual features 302 and 304.

In other embodiments, trained programmatic base 106 may be configured to associate a URL (e.g., URL 308) corresponding with a webpage, such as webpage 300 with webpage text such as webpage text 306. For example, trained programmatic base 106 may associate URL 308 and thereby webpage 300 with aspects of webpage text 306. When user 104 sends search instructions (such as instructions 210) corresponding with aspects of webpage text 306 (such as text color, font, font size, and the like), trained programmatic base 106 may produce search results 208 corresponding with URL 308, and thereby webpage 300, allowing user 104 to access webpage 300 based solely on knowledge of aspects of webpage text 306 (such as text color, font, size, and the like).

In other embodiments, the system may store temporal information related to when the webpages were accessed and then searched based on this temporal information.

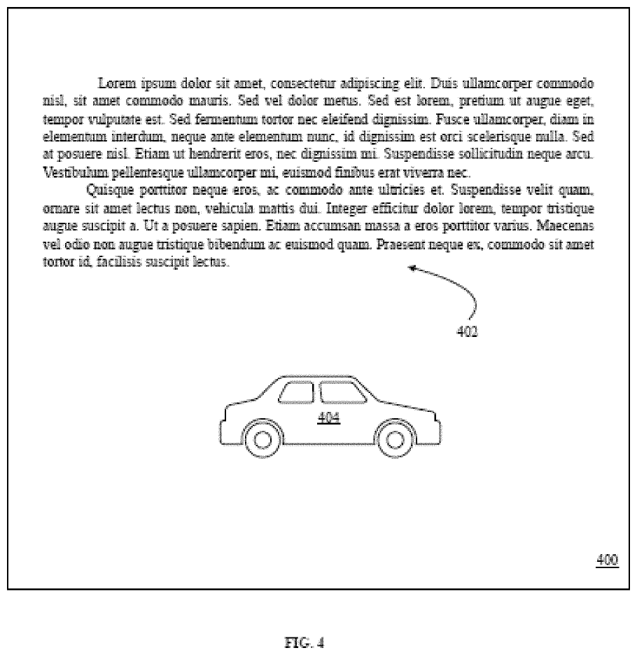

FIG. 4 illustrates an exemplary file comprising visual features, consistent with some embodiments of the disclosure. As shown in FIG. 4, document 400 may comprise document visual feature 404 and document text 402. In some embodiments, there may be multiple document visual features. Each of the document visual features 404 may have a shape, color, silhouette, patterns, and other attributes. Document visual attributes, such as document visual feature 404, may refer to shapes, images, patterns, or even background colors.

In some embodiments, there may also be document text, such as document text 402, associated with a document, such as document 400. Document text 402 may include aspects of document text such as text color, font, size, special characters, columns, tables, and the like.

In some embodiments, trained programmatic base 106 may be configured to analyze documents, such as document 400, and extract and analyze details about visual features, such as visual feature 404. Trained programmatic base 106 may contain a machine learning module that is programmed and/or trained to determine visual features based on document information (which includes document content). For example, document visual feature 404 may be analyzed and determined to be an image of a car or motor vehicle. Furthermore, a color or colors may be determined for document visual feature 404.

In some embodiments, trained programmatic base 106 may be configured to associate a document (e.g., document 400) with document visual features, such as document visual feature 404. For example, trained programmatic base 106 may associate document 400 with a visual feature summary 218 based on document visual features 404. When user 104 sends search instructions corresponding with visual feature 404 (a car), trained programmatic base 106 may produce search results 208 corresponding with document 400, allowing user 104 to access document 400 based solely on knowledge of document visual feature 404.

In other embodiments, trained programmatic base 106 may be configured to associate a document (e.g., document 400) with temporal information, such as temporal information 216. For example, trained programmatic base 106 may associate document 400 with a temporal information 216 based on when a user action (edits, saves, moves, and the like) is performed on document 400. When user 104 sends search instructions corresponding with temporal information 216, trained programmatic base 106 may produce search results 208 corresponding with document 400, allowing user 104 to access document 400 based solely on knowledge of temporal information 216. For example, user 104 may send search results requests documents saved or accessed at a given point in time. Trained programmatic base 106 may then analyze temporal information 216 and identify document 400 as corresponding with a user action of saving or access at the given point in time.

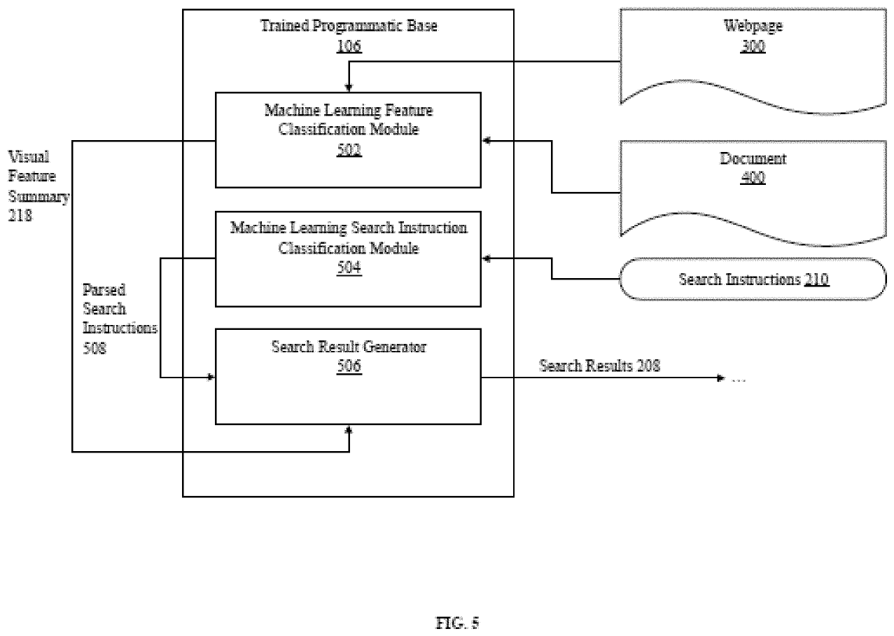

FIG. 5 illustrates a block diagram of an exemplary trained programmatic base, consistent with some embodiments of this disclosure. As shown in FIG. 5, trained programmatic base 106 may comprise machine learning feature classification module 502, machine learning search instruction classification module 504, and search result generator 506.

As shown in FIG. 5, machine learning feature classification module 502 may be configured to receive webpage information such as webpage information 212 from webpage 300 and may be further configured to receive document information, such as document information 214, from document 400.

In some embodiments, machine learning feature classification module 502 may run machine learning based analysis on webpage information 212 and document information 214 to extract visual features (such as visual features 302, 304, and 404). For example, machine learning feature classification module 502 may use supervised or unsupervised learning. Machine learning feature classification module 502 may use linear regression, Bayes classifiers, k-means clustering, neural networks, other known and as yet undiscovered machine learning methods, or some combination of these machine learning methods. In some embodiments, machine learning feature classification module 502 may be pre-trained on feature detection. Machine learning feature classification module 502 may also further learn feature detection based on the correlation between search instructions 210 and search results 208 which prove successful.

As shown in FIG. 5, machine learning search instruction classification module 504 may be configured to receive search instructions 210 from user 104. For example, user 104 may input search instructions 210 into a search application (such as search application 200) which may then send search instructions 210 to machine learning search instruction classification module 504.

In some embodiments, machine learning search instruction classification module 504 may run machine learning based analysis on search instructions 210 to generate parsed search instructions 508. For example, machine learning search instruction classification module 504 may use supervised or unsupervised learning. Machine learning feature classification module 502 may use linear regression, Bayes classifiers, k-means clustering, neural networks, and/or other known and as yet undiscovered machine learning methods, or some combination of these machine learning methods. In some embodiments, machine learning search instruction classification module 504 may be pre-trained (programmed) on feature detection based on search terms. Machine learning search instruction classification module 504 may also further learn feature detection based on the correlation between search instructions 210 and search results 208 that prove successful (by virtue of user selection and/or user survey).

As shown in FIG. 5, search result generator 506 may be configured to receive visual feature summary 218 from machine learning feature classification module 502. Search result generator 506 may be further configured to receive parsed instructions 508 from machine learning search instruction classification module 504. Search result generator 506 may also be configured to send search results 208 to a search application, such as search application 200.

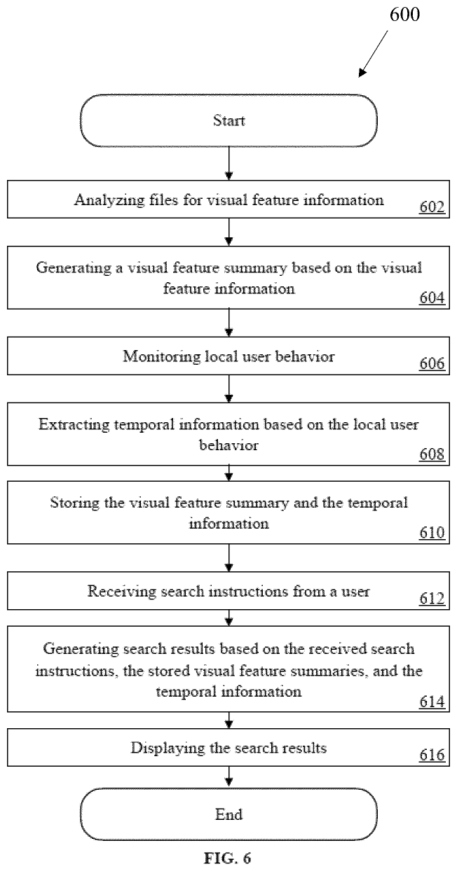

FIG. 6 is a flowchart of an exemplary method 600 for temporal and visual feature driven search utilizing machine learning, consistent with some embodiments of this disclosure. The exemplary method 600 may be performed by a processor of a device, such as a smart phone, a tablet, a personal computer (PC), or the like.

In step 602, the processor analyzes files for visual feature information. For example, the processor may use a trained machine learning module to determine visual feature information associated with a file. In some embodiments, the processor may determine that a file contains an image and classify the image based on visual features inside the image. In some embodiments, the processor may determine that a file contains a background color and classify the image based on the background. In some embodiments, the processor may determine that a file contains a certain color of text and classify the image based on the text color. In some embodiments, the processor may make all of these classifications for one given file. The files being analyzed may be documents or webpages and may be of any format.

In step 604, the processor generates a visual feature summary based on the visual feature information. For example, the processor may use the visual feature information from the classifications in step 602 and generate a summary representing all of the visual features contained in the file.

In step 606, the processor monitors local user behavior. For example, the processor may catalog user actions such as saving a file. In some embodiments, the processor may determine a time, date, place, or other information associated with the user action. In some embodiments, therefore, local user behavior may comprise user actions as well as the time, date, place, and other associated information.

In step 608, the processor extracts temporal information based on the local user behavior. For example, the processor may take the local user behavior and determine the time and date associated with a given user action.

In step 610, the processor stores the visual feature summary and the temporal information. For example, the processor may take the visual feature summary generated in step 604 and the temporal information extracted in step 608 and store both the visual feature summary and temporal information. The processor may store the visual feature summary and temporal information locally or remotely.

In step 612, the processor receives search instructions from a user. For example, the processor may process text or audio input from a user of a device and determine the search criteria associated with the text or audio input.

In step 614, the processor generates search results based on the received search instructions, the stored visual feature summaries, and the temporal information. For example, the processor may use the search criteria determined from the search instruction in step 612 and compare them against visual feature summaries and temporal information stored in step 610. As an example, the search criteria may correspond with a visual feature such as a face and also correspond with a time of noon of the previous day. The processor may then search stored visual features summaries for a visual feature summary that include a face and temporal information associated with noon of the previous day.

In step 616, the processor displays the search results. For example, the processor may direct the user to a determined web page or document. The processor may provide a link to the determine web page or document. The processor may also automatically open the determined web page or document.

In some embodiments, a non-transitory computer readable storage medium including instructions is also provided, and the instructions may be executed by a device (such as a terminal, a personal computer, or the like), for performing the above-described methods.

Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, A PROM, and EPROM, a FLASH-EPROM or any other flash memory, NVRAM, a cache, a register, any other memory chip or cartridge, and networked versions of the same. The device may include one or more processors (CPUs), an input/output interface, a network interface, and/or a memory.

It should be noted that, the relational terms herein such as “first” and “second” are used only to differentiate an entity or operation from another entity or operation, and do not require or imply any actual relationship or sequence between these entities or operations. Moreover, the words “comprising,” “having,” “containing,” and “including,” and other similar forms are intended to be equivalent in meaning and be open ended in that an item or items following anyone of these words is not meant to be an exhaustive listing of such item or items, or meant to be limited to only the listed item or items.

One of ordinary skill in the art will understand that the above-described embodiments can be implemented by hardware, or software (program codes), or a combination of hardware and software. If implemented by software, it may be stored in the above-described computer-readable media. The software, when executed by the processor can perform the disclosed methods. The computing units and other functional units described in this disclosure can be implemented by hardware, or software, or a combination of hardware and software. One of ordinary skill in the art will also understand that multiple ones of the above-described modules/units may be combined as one module/unit, and each of the above-described modules/units may be further divided into a plurality of sub-modules/sub-units.

Other embodiments of the systems and methods of the present disclosure will be apparent to those skilled in the art from consideration of the specification and practice of the systems and methods of the present disclosure disclosed here. This disclosure is intended to cover any variations, uses, or adaptations of the disclosed embodiments following the general principles thereof and including such departures from the present disclosure as come within known or customary practice in the art. It is intended that the specification and examples be considered as exemplary only, with a true scope and spirit of the systems and methods of the present disclosure being indicated by the following claims.

It will be appreciated that the systems and methods of the present disclosure are not limited to the exact construction that has been described above and illustrated in the accompanying drawings, and that various modifications and changes can be made without departing from the scope thereof. It is intended that the scope of the systems and methods of the present disclosure should only be limited by the appended claims.

Some portions of the preceding detailed descriptions have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it should be appreciated that throughout the present disclosure, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system's memories or registers or other such information storage, transmission or display devices.

The techniques shown in the figures can be implemented using code and data stored and executed on one or more electronic devices. Such electronic devices store and communicate (internally and/or with other electronic devices over a network) code and data using computer-readable media, such as non-transitory computer-readable storage media (e.g., magnetic disks; optical disks; random access memory; read only memory; flash memory devices; phase-change memory) and transitory computer-readable transmission media (e.g., electrical, optical, acoustical or other form of propagated signals—such as carrier waves, infrared signals, digital signals).

The processes or methods depicted in the figures may be performed by processing logic that comprises hardware (e.g. circuitry, dedicated logic, etc.), firmware, software (e.g., embodied on a non-transitory computer readable medium), or a combination thereof. Although the processes or methods are described above in terms of some sequential operations, it should be appreciated that some of the operations described may be performed in a different order. Moreover, some operations may be performed in parallel rather than sequentially.

While the present disclosure has been described in terms of particular variations and illustrative figures, those of ordinary skill in the art will recognize that the disclosure is not limited to the variations or figures described. In addition, where methods and steps described above indicate certain events occurring in certain order, those of ordinary skill in the art will recognize that the ordering of certain steps may be modified and that such modifications are in accordance with the variations of the systems and methods of the present disclosure. Additionally, certain of the steps may be performed concurrently in a parallel process when possible, as well as performed sequentially as described above. To the extent there are variations of the systems and methods of the present disclosure, which are within the spirit of the disclosure or equivalent to the systems and methods of the present disclosure found in the claims, it is the intent that this patent will cover those variations as well. Therefore, the present disclosure is to be understood as not limited by the specific embodiments described herein, but only by scope of the appended claims.

The foregoing description of the preferred embodiment has been presented for the purposes of illustration and description. While multiple embodiments are disclosed, still other embodiments will become apparent to those skilled in the art from the above detailed description, which shows and describes the illustrative embodiments. As will be realized, these embodiments are capable of modifications in various obvious aspects, all without departing from the spirit and scope of the present disclosure. Accordingly, the detailed description is to be regarded as illustrative in nature and not restrictive. Also, although not explicitly recited, one or more additional embodiments may be practiced in combination or conjunction with one another. Furthermore, the reference or non-reference to a particular embodiment shall not be interpreted to limit the scope of protection. It is intended that the scope of protection is not limited by this detailed description, but by the claims and the equivalents to the claims that are appended hereto.

Except as stated immediately above, nothing which has been stated or illustrated is intended or should be interpreted to cause a dedication of any component, step, feature, object, benefit, advantage, or equivalent to the public, regardless of whether it is or is not recited in the claims.

I claim:

1. A system for temporal and visual feature driven search utilizing machine learning comprising:
a trained programmatic base configured to analyze files for visual feature information, generate a visual feature summary based on said visual feature information, and send said visual feature summary to a database;
said database configured to receive said visual feature summary from said trained programmatic base and store said visual feature summary;
a local monitoring device configured to monitor local user behavior, extract temporal and visual information of said files based on said local user behavior, and send said temporal and visual information of said files to said trained programmatic base; and
a search application device configured to receive search instructions from a user and send said search instructions to said trained programmatic base and wherein said search application device is also configured to receive search results from said trained programmatic base and display said search results to said user.

2. The system of claim 1, wherein said trained programmatic base further comprises one or more trained machine learning models and wherein said trained programmatic base is further configured to generate said visual feature summary based on said one or more trained machine learning models and said visual feature information of said files.

3. The system of claim 1, wherein said database comprises a cloud storage database.

4. The system of claim 1, wherein said files comprise one or more webpages.

5. The system of claim 1, wherein the files comprise one or more documents.

6. The system of claim 1, wherein said visual feature information is information selected from the group of information consisting of one or more of: pictures; backgrounds; text color; and combinations thereof.

7. The system of claim 1, wherein said local user behavior comprises editing and saving one or more documents.

8. A method for temporal and visual feature driven search utilizing machine learning comprising:
analyzing files for visual feature information;
generating a visual feature summary based on said visual feature information;
monitoring local user behavior;
extracting temporal and visual information based on said local user behavior;
storing said visual feature summary and said temporal and visual information;
receiving search instructions from a user;
generating search results based on said search instructions, said stored visual feature summaries, and said temporal and visual information; and
displaying said search results.

9. The method of claim 8, wherein said generating of said visual feature summary is further based on one or more trained machine learning models.

10. The method of claim 8, wherein said storing of said visual feature summary and said temporal and visual information comprises storing said visual feature summary and said temporal and visual information in a cloud storage database.

11. The method of claim 8, wherein said files comprise one or more webpages.

12. The method of claim 8, wherein said files comprise one or more documents.

13. The method of claim 8, wherein said visual feature information is information selected from the group of information consisting of one or more of: pictures; backgrounds; text color; and combinations thereof.

14. The method of claim 8, wherein said local user behavior comprises editing and saving one or more documents.

15. A non-transitory computer-readable storage medium that stores a set of instructions that is executable by at least one processor of a temporal and visual feature driven search device to cause the temporal and visual feature driven search device to perform a method comprising:
analyzing files for visual feature information;
generating a visual feature summary based on said visual feature information;
monitoring local user behavior;
extracting temporal and visual information based on said local user behavior;
storing said visual feature summary and said temporal and visual information;
receiving search instructions from a user;
generating search results based on said search instructions, said stored visual feature summaries, and said temporal and visual information; and
displaying said search results to said user.

16. The non-transitory computer-readable storage medium of claim 15, wherein said generating of said visual feature summary is further based on one or more trained machine learning models.

17. The non-transitory computer-readable storage medium of claim 15, wherein said storing of said visual feature summary and said temporal and visual information comprises storing said visual feature summary and said temporal and visual information in a cloud storage database.

18. The non-transitory computer-readable storage medium of claim 15, wherein said files comprise one or more webpages.

19. The non-transitory computer-readable storage medium of claim 15, wherein said files comprise one or more documents.

20. The non-transitory computer-readable storage medium of claim 15, wherein said visual feature information is information selected from the group of information consisting of one or more of: pictures; backgrounds; text color; and combinations thereof.
